(19) United States
(12) Patent Application Publication
(10) Pub. No.: US 2017/0340073 A1
(43) Pub. Date: Nov. 30, 2017

(54) Wrist Flashlight(watch light)

(71) Applicant: Valeria Buchanan, NORCROSS, GA (US)

(72) Inventor: Valeria Buchanan, NORCROSS, GA (US)

(21) Appl. No.: 14/999,584

(22) Filed: May 31, 2016

(51) Int. Cl. A44C 15/00; A44C 5/00; F21V 23/04; F21L 4/04; F21Y 2115/10

(52) U.S. Cl. CPC A44C 15/0015; F21V 23/0414; F21L 4/04; A44C 5/0053; A44C 5/0007; F21Y 2115/10

(57) ABSTRACT

Watch Light is a new flashlight created to be worn on the wrist to enhance visibility. This design with its ease of use will be a tool to be used to assist a person in need of additional lighting, in which Watch Light will be very useful for a person that may be visually impaired. The Watch Light design will be created to be used in many industries promoting productivity. Senior citizens, children, and the average homemaker will all find the advantages and convenience of having additional light immediately at the touch of a button when needed by wearing Watch Light. Watch Light will be useful when in dark areas where it may be to see how to open a door, assist in walking, especially when walking in dark areas where there may be stairs, with Watch Light you will be hands free and able to hold onto a hand rail. The Watch Light will be very useful in any circumstance where there may be poor lighting keeping hands free for whatever is needed.

### CROSS-REFERENCE TO RELATED APPLICATIONS

Provisional Patent No. 62/230,357

### STATEMENT IN REGARDS TO FEDERALLY SPONSORED RESEARCH

There has been no federally sponsored research or development on this matter.

There are no parties to a joint research agreement.

### BACKGROUND OF THE INVENTION

I Valeria Buchan have disclosed this concept to a company known as Invent Help. I have also disclosed this concept to Ravi Navare owner of CPI Innovations located in Marietta Georgia, whereby he was to create the prototype of my intellectual property but was misled.

Research of this design invention was done by Patent Attorney Thomas Frost located at 600 Fourth Street North, Suite 102 St. Petersburg, Fla. 33702 viewing the following Patents. U.S. Design Patent Des. 127,597 U.S. Utility patent Ser. No. 3,112,889 U.S. Design Patent Des. 324,579 U.S. Utility patent Ser. No. 5,601,356, U.S. Utility patent Ser. No. 6,213,619 Foreign Patent Document CN201696879U

The endeavor of this creation by Valeria Buchanan is to be placed in the area of Utility and or Design Patent within the USTPO with a modern, unique classy appearance. The design will be adjusted to capture all walks of life including children, senior citizens, industrial workers and more with the ease of its use providing lighting for any circumstance. Think of how much fun it would be if children had a cool flashlight on the arm while Trick or Treating or maybe just at a football game at night. This creation by far has many advantages for everyone with a Trendy look, it's ease of placing on the wrist, changing the battery all in one stylish component along with the easily accessible on/off button. Previously a flash light in natural form would have to be buckled into a strap that was placed on a person's wrist to stabilize the light. This design will not only be a single component, it will also be upgraded to swivel.

### DETAILED DESCRIPTION

The Watch Light will be composed in the following descriptions.

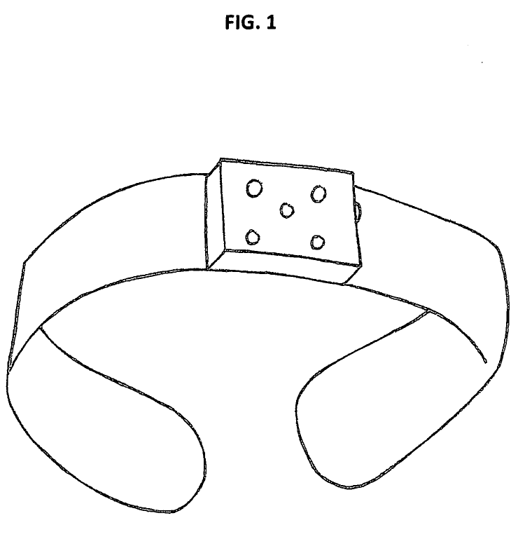

FIG. 1, is a complete view of the appearance of the design Watch Light

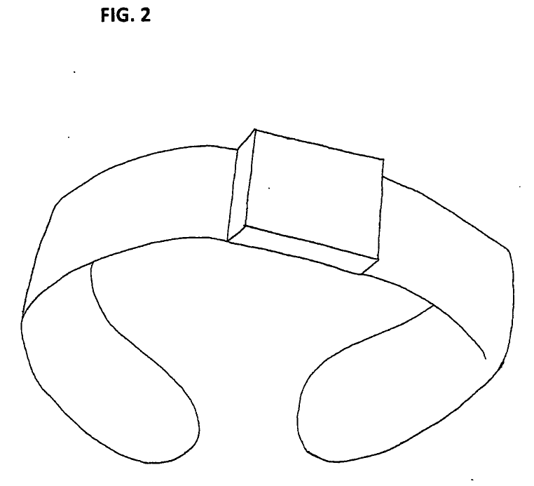

FIG. 2, Wrist band made of Elastomeric Plastic. Elastomers are amorphous polymers existing above their glass transition temperature, so that considerable segmental motion is possible. At ambient temperatures, rubbers are thus relatively soft and deformable.

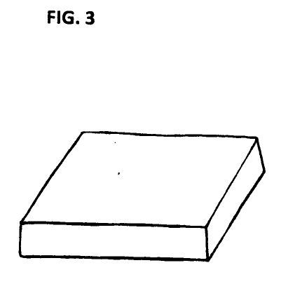

FIG. 3. housing compartment which will encompass LED lights, coin battery.

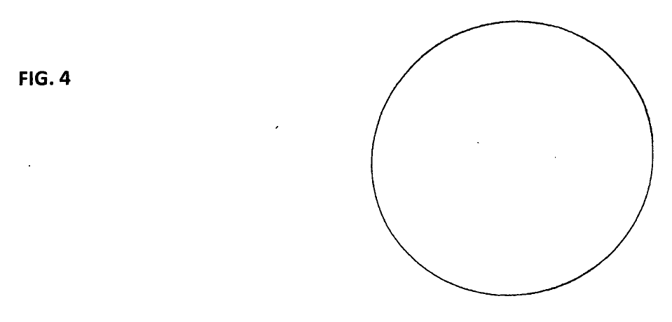

FIG. 4. coin battery that will be housed within the housing compartment.

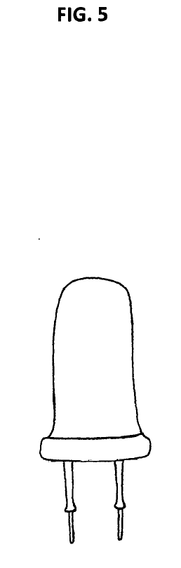

FIG. 5. LED light bulb whereby there will be multiple bulbs.

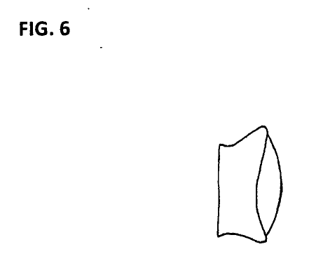

FIG. 6. on/off button which will be located on side of housing unit which function will illuminate light by inward pushing on the designated button.

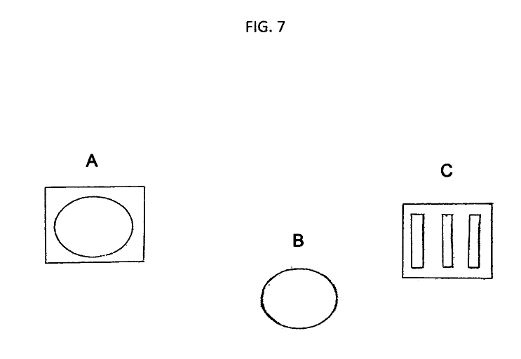

FIG. 7.

A. wrist band battery housing

B. coin battery,

C. back of housing with magnetic strips that will attach to the top of the wrist band magnetic strip for easy removal of batteries.

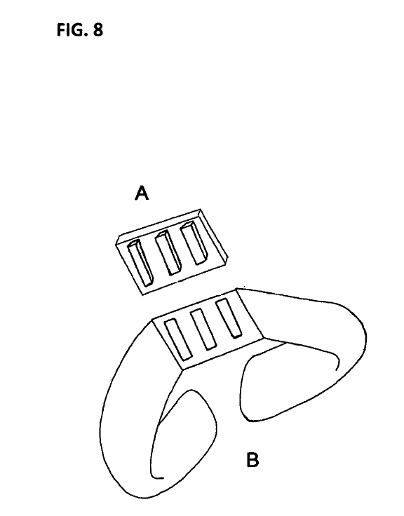

FIG. 8

A, bottom of housing compartment with magnetic strips

B. magnetic foundation of the Elastomeric wrist band.

1. I Valeria Buchanan claimed that I am the true original inventor of this design type of wrist flashlight to be worn on the wrist.

2. I Valeria Buchanan claim that I am the true and original inventor of upgrading this design of the wrist flash light by swivel and or clockwise motion.
